(19) United States
(12) Patent Application Publication
(10) Pub. No.: US 2026/0143545 A1
(43) Pub. Date: May 21, 2026

(54) Methods And Apparatus For Handling PDU Session Re-Establishment Procedures

(71) Applicant: MediaTek Inc., Hsinchu City (TW)

(72) Inventors: Ren-Huang Liu, Hsinchu City (TW); Chin-Te Chen, Hsinchu City (TW)

(73) Assignee: MediaTek Inc., Hsinchu City (TW)

(21) Appl. No.: 19/372,267

(22) Filed: Oct. 29, 2025

Related U.S. Application Data
(60) Provisional application No. 63/723,158, filed on Nov. 21, 2024.

(51) Int. Cl. H04W 76/19; H04W 60/04; H04W 76/30

(52) U.S. Cl. CPC H04W 76/19; H04W 60/04; H04W 76/30

(57) ABSTRACT

Various solutions for handling Protocol Data Unit (PDU) session re-establishment procedures are described. A user equipment (UE) may transmit a request message to a network node. Then, the UE may receive an accept message responding to the request message from the network node. The accept message may include a cause value for releasing a session. The UE may determine whether to re-establish a session according to the cause value.

### CROSS REFERENCE TO RELATED PATENT APPLICATION(S)

The present disclosure is part of a non-provisional application claiming the priority benefit of U.S. Application No. 63/723,158, filed 21 Nov. 2024, the content of which herein being incorporated by reference in its entirety.

### TECHNICAL FIELD

The present disclosure is generally related to wireless communications and, more particularly, to a method and apparatus for handling Protocol Data Unit (PDU) session re-establishment procedures.

### BACKGROUND

Unless otherwise indicated herein, approaches described in this section are not prior art to the claims listed below and are not admitted as prior art by inclusion in this section.

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless networks, such as GSM, CDMA, and Universal Mobile Telecommunication System (UMTS). In LTE systems, an Evolved Universal Terrestrial Radio Access Network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The next generation mobile network (NGMN) board has decided to focus the future NGMN activities on defining the end-to-end requirements for 5G New Radio (NR) systems.

In a 5G/NR system, the UE accesses a data network by establishing a Protocol Data Unit (PDU) session. Each PDU session is identified by a PDU session identity (PSI), which is assigned within a predefined range (e.g., 1 to 15). When the network intends to release a PDU session, it initiates a PDU session release procedure by transmitting a PDU session release command message to the UE, the PDU session release command message indicating the PSI to be released. Upon reception of the PDU session release command message, the UE responds with a PDU session release complete message, and thereafter, both the UE and the network consider the corresponding PDU session as released.

In addition, synchronization of active PDU sessions between the UE and the network may be achieved by means of a PDU session status information element (IE), which may be included in a registration request message and a registration accept message. When a PDU session remains active on the UE side but has already been deactivated on the network side, the UE locally releases the PDU session upon receiving the corresponding PDU session status IE.

However, problems may arise when the UE is located in an area with poor or no radio signal. Under such circumstances, a PDU session release command message transmitted by the network may fail to be delivered to the UE. In this case, since the network does not receive the corresponding PDU session release complete message from the UE, the network may decide to locally release the PDU session. Later, when the UE performs a registration procedure, the UE may become aware of the deactivation through the PDU session status IE and locally release the PDU session accordingly. Nevertheless, since the UE does not know the reason why the network has released the PDU session, the UE may attempt to re-establish the locally released PDU session by initiating a new PDU session establishment procedure. Such a procedure, however, may be rejected by the network, which can lead to unnecessary signaling and inefficiency.

Therefore, a solution is needed to enable the UE to know the reason why the network releases the PDU session so that the operation can be more efficient.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to handling PDU session re-establishment procedures.

In one aspect, a method may involve an apparatus transmitting a request message to a network node. The method may also involve the apparatus receiving an accept message responding to the request message from the network node. The accept message may comprise a cause value for releasing a session. The method may further involve the apparatus determining whether to re-establish a session according to the cause value.

In another aspect, an apparatus may comprise a transceiver which, during operation, wirelessly communicates with a network. The apparatus may also comprise a processor communicatively coupled to the transceiver. The processor, during operation, may perform operations comprising transmitting, via the transceiver, a request message to a network node. The processor, during operation, may also perform operations receiving, via the transceiver, an accept message responding to the request message from the network node. The accept message may comprise a cause value for releasing a session. The processor, during operation, may further perform operations determining whether to re-establish a session according to the cause value.

In another aspect, a method may involve a network node determining to release a session with a user equipment (UE). The method may also involve the network node including a cause value for releasing the session in an accept message. The method may further involve the network node transmitting the accept message to the UE.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale, as some components may be shown to be out of proportion than the size in actual implementation in order to clearly illustrate the concept of the present disclosure.

FIG. 1 illustrates an exemplary New Radio (NR) network for handling protocol data unit (PDU) session re-establishment procedures in accordance with implementations of the present disclosure.

FIG. 2 illustrates a diagram depicting an exemplary procedure for handling the PDU session re-establishment procedure in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling PDU session re-establishment procedures. According to the present disclosure, a number of possible solutions may be implemented separately or jointly. That is, although these possible solutions may be described below separately, two or more of these possible solutions may be implemented in one combination or another.

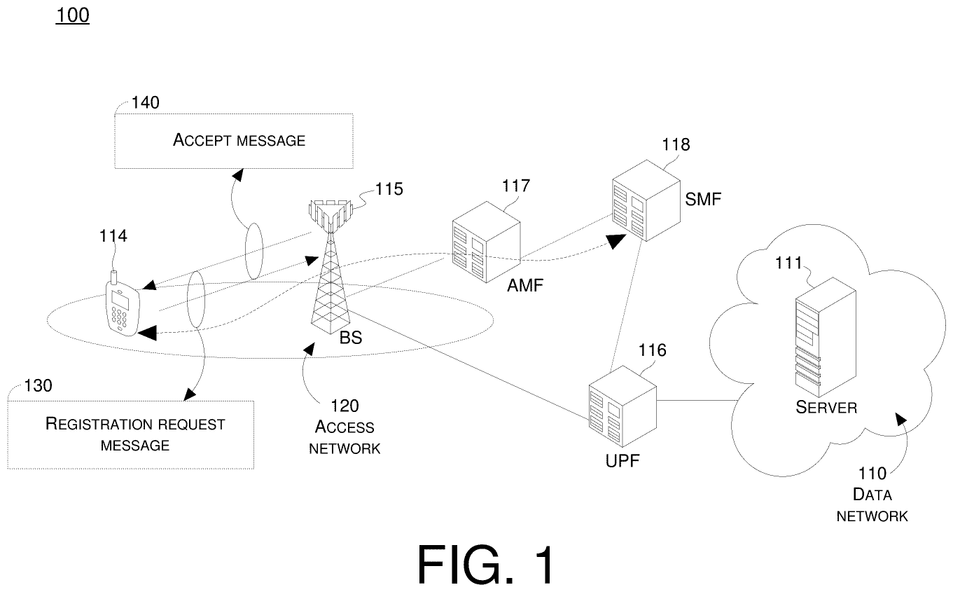

FIG. 1 illustrates an exemplary NR network 100 handling protocol data unit (PDU) session re-establishment procedures in accordance with implementations of the present disclosure. The NR network 100 comprises a data network 110 and an application server 111 that provides various services by communicating with a plurality of user equipment (UEs), including UE 114. In the example of FIG. 1, the UE 114 and its serving base station (BS) 115 belong to part of a radio access network (RAN) 120. The RAN 120 provides radio access for the UE 114 via a radio access technology (RAT). An application server 111 communicates with the UE 114 through a User Plane Function (UPF) 116 and the BS 115. An access and mobility management function (AMF) 117 communicates with the BS 115 for access and mobility management of wireless access devices in the NR network 100. A Session Management Function (SMF) 118 is primarily responsible for interacting with the decoupled data plane, creating, updating, and removing Protocol Data Unit (PDU) sessions and managing session context with the UPF 116. The UE 114 may be equipped with a radio frequency (RF) transceiver or multiple RF transceivers for different application services via different RATs/CNs. The UE 114 may be a smartphone, a wearable device, an Internet of Things (IoT) device, a tablet, etc.

In 5G/NR, a Protocol Data Unit (PDU) session defines the association between the UE and the data network that provides a PDU connectivity service. Each PDU session is identified by a PDU session identity (PSI), and may include multiple QoS flows and QoS rules. The network or the UE may initiate different PDU session procedures, e.g., PDU session establishment, PDU session modification, and PDU session release procedures. When UE receives a PDU session release command message from the network, the UE sends a PDU session release complete message back to the network. However, when the UE is located in an area with poor or no signal, the PDU session release command message transmitted by the network may not be received by the UE. In such a case, the network may locally release the session, and the UE later becomes aware of the release through the PDU session status IE during registration. Since the UE does not know the reason for the release, the UE may attempt to re-establish the session, which may be rejected by the network and result in unnecessary signaling.

In accordance with one novel aspect, at the UE side, the UE 114 first initiates a registration procedure by sending a registration request message 130 to the base station 115. When the UE 114 later receives an accept message 140 that comprises a cause value for releasing a session from the base station 115, the UE 114 determines whether to re-establish the session according to the cause value.

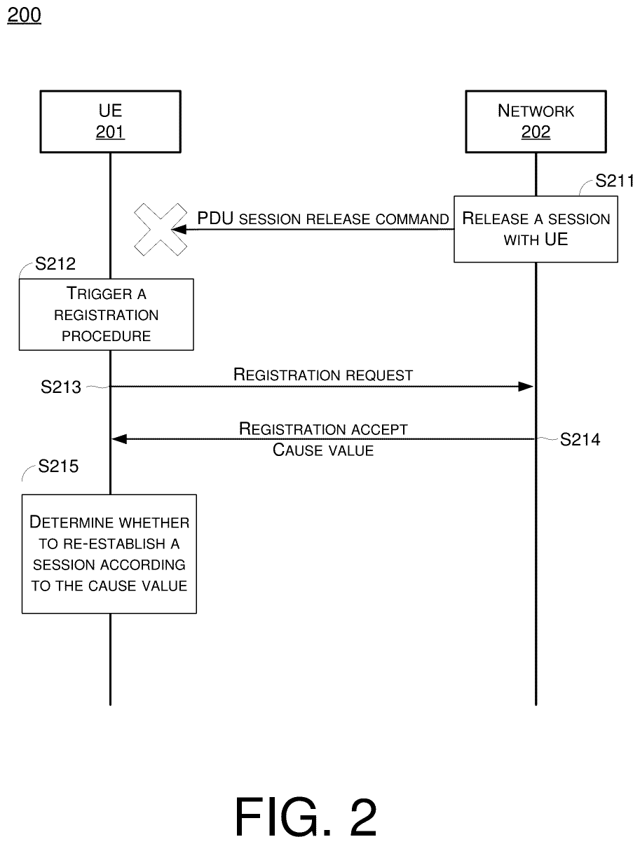

FIG. 2 illustrates a diagram depicting an exemplary procedure 200 for handling the PDU session re-establishment procedure in accordance with implementations of the present disclosure.

In step S211, the network 202 determines to release a session with the UE 201 by sending a PDU session release command message to the UE 201. Note that the network 202 may refer to any node within a wireless communication network. For example, the network 202 may correspond to an access node (e.g., a base station, eNB, or gNB) or a core network node (e.g., AMF, SMF, or other core network entity). The network 202 may initiate the release of a PDU session with the UE 201 for various reasons, including policy or subscription restrictions, resource management considerations, error handling (e.g., abnormal session establishment or context inconsistency), and mobility-related procedures where the session cannot be maintained. In these cases, the network 202 may transmit a PDU session release command message to the UE 201 to terminate the corresponding session. However, the PDU session release command message does not reach the UE 201.

In step S212, the UE 201 may trigger a registration procedure. For example, the UE 201 may trigger the registration procedure in several situations, including periodic registration update, mobility across registration areas, recovery from a failed service request, loss or invalidation of a security or session context, and when specific services such as emergency services, SMS-only services, or voice fallback are required.

In step S213, the UE 201 may then transmit a request message (e.g., REGISTRATION REQUEST) to the network 202 to initiate a registration procedure.

In step S214, the UE 201 receives an accept message (e.g., REGISTRATION ACCEPT) from the network 202, wherein the accept message may also comprise a cause value for releasing the session. In one embodiment, the cause value may include at least one of the cause codes #8 corresponding to “operator determined barring”, #26 corresponding to “insufficient resources”, #29 corresponding to “user authentication or authorization failed”, #36 corresponding to “regular deactivation”, #38 corresponding to “network failure”, #39 corresponding to “reactivation requested”, #46 corresponding to “out of Local Area Data Network(LADN) service area”, #67 corresponding to “insufficient resources for specific slice and data network name (DNN)”, #69 corresponding to “insufficient resources for specific slice”, and the like.

In step S215, the UE 201 determines whether to re-establish the session according to the cause value. In some embodiments, the UE 201 may perform, according to the cause value, at least one of the following actions: re-establishing the session, re-establishing the session in response to an expiration of a timer, and not re-establishing the session. For example, when the cause code is #36 corresponding to “regular deactivation”, or #39 corresponding to “reactivation requested”, the UE 201 may re-establish the session. When the cause code is #26 corresponding to “insufficient resources”, #67 corresponding to “insufficient resources for specific slice and data network name”, or #69 corresponding to “insufficient resources for specific slice”, the UE 201 may re-establish the session in response to an expiration of a timer. When the cause code is #8 corresponding to “operator determined barring”, #29 corresponding to “user authentication or authorization failed”, #38 corresponding to “network failure”, or #46 corresponding to “out of LADN service area”, the UE 201 may not re-establish the session.

It should be understood that although FIG. 2 illustrates the registration procedure by way of a registration request and a registration accept, the present disclosure is not limited thereto. In certain cases, the request message may instead be a service request message, and the corresponding message may be a service accept message.

### Illustrative Implementations

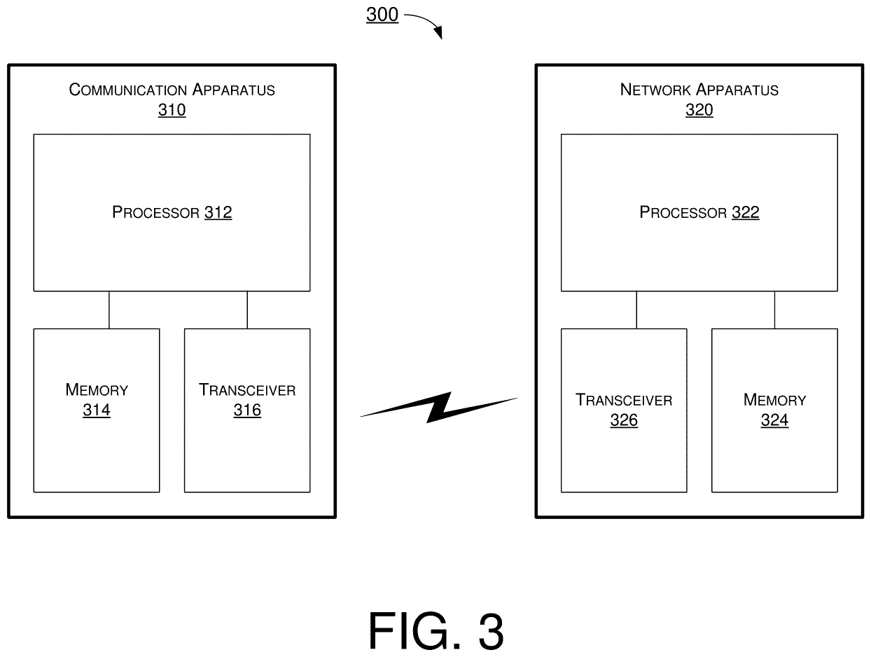

FIG. 3 illustrates an example communication system 300 having at least an example communication apparatus 310 and an example network apparatus 320 in accordance with an implementation of the present disclosure. Each of the communication apparatus 310 and network apparatus 320 may perform various functions to implement schemes, techniques, processes, and methods described herein of handling PDU session re-establishment procedures, including scenarios/schemes described above, as well as processes 400 and 500 described below.

Communication apparatus 310 may be a part of an electronic apparatus, which may be a UE such as a portable or mobile apparatus, a wearable apparatus, a wireless communication apparatus, or a computing apparatus. For instance, communication apparatus 310 may be implemented in a smartphone, a smartwatch, a personal digital assistant, a digital camera, or a computing equipment such as a tablet computer, a laptop computer, or a notebook computer. Communication apparatus 310 may also be a part of a machine type apparatus, which may be an IoT, NB-IoT, or IIoT apparatus, such as an immobile or a stationary apparatus, a home apparatus, a wire communication apparatus, or a computing apparatus. For instance, communication apparatus 310 may be implemented in a smart thermostat, a smart fridge, a smart door lock, a wireless speaker, or a home control center. Alternatively, communication apparatus 310 may be implemented in the form of one or more integrated-circuit (IC) chips, such as, for example, and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3, such as a processor 312, for example. Communication apparatus 310 may further include one or more other components not pertinent to the proposed scheme of the present disclosure (e.g., internal power supply, display device, and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router, or a gateway. For instance, network apparatus 320 may be implemented in an eNB in an LTE network, in a gNB in a 5G/NR, IoT, NB-IoT or IIoT network, or in a satellite or base station in a 6G network. Network apparatus 320 may include at least some of those components shown in FIG. 3, such as a processor 322, for example. Processor 322 may further include protocol stacks and a set of control functional modules and circuits. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of the processor 312 and processor 322 may be implemented in the form of one or more single-core processors, one or more multi-core processors, or one or more CISC processors. That is, even though a singular term “a processor” is used herein to refer to processor 312 and processor 322, each of the processor 312 and processor 322 may include multiple processors in some implementations and a single processor in other implementations in accordance with the present disclosure. In another aspect, each of the processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and processor 322 is a special-purpose machine specifically designed, arranged, and configured to perform specific tasks in a device (e.g., as represented by communication apparatus 310) and a network (e.g., as represented by network apparatus 320) in accordance with various implementations of the present disclosure.

In some implementations, communication apparatus 310 may also include a memory 314 coupled to processor 312 and capable of being accessed by processor 312 and storing data therein. In some implementations, communication apparatus 310 may further include a transceiver 316 coupled to processor 312 and capable of wirelessly transmitting and receiving data. In some implementations, transceiver 316 may be capable of wirelessly communicating with different types of UEs and/or wireless networks of different RATs, e.g., 2G GSM, 3G UMTS, 4G LTE, 5G NR, and/or 6G.

In some implementations, network apparatus 320 may further include a memory 324 coupled to processor 322 and capable of being accessed by processor 322 and storing data therein, and a transceiver 326 coupled to processor 322 and capable of wirelessly transmitting and receiving data. Accordingly, communication apparatus 310 and network apparatus 320 may wirelessly communicate with each other via transceiver 316 and transceiver 326, respectively.

For illustrative purposes and without limitation, descriptions of capabilities of the communication apparatus 310 and network apparatus 320 are provided below with process 400 and process 500. In which, communication apparatus 310 is implemented in or as a communication apparatus or a UE, and network apparatus 320 is implemented in or as a network node of a communication network (e.g., a core network node).

### Illustrative Processes

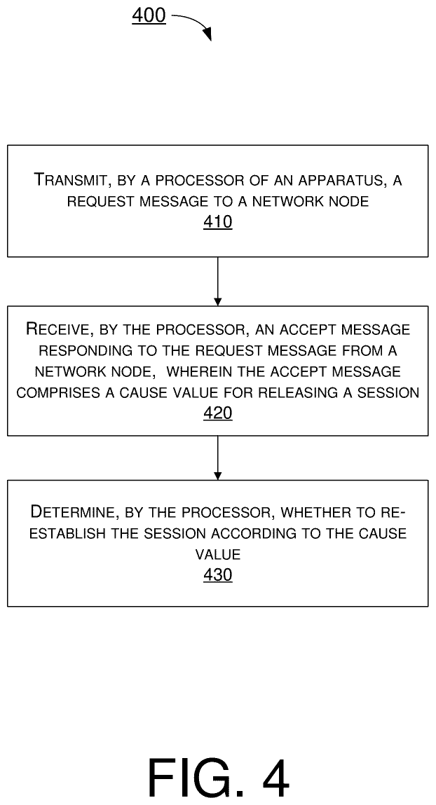

FIG. 4 illustrates an example process 400 in accordance with an implementation of the present disclosure. Process 400 may be an example implementation of the above scenarios/schemes, whether partially or completely, with respect to handling PDU session re-establishment procedures. Process 400 may represent an aspect of the implementation of features of communication apparatus 310. Process 400 may include one or more operations, actions, or functions as illustrated by one or more of blocks 410, 420, and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE (e.g., UE 114) or machine-type devices. Solely for illustrative purposes and without limitation, process 400 is described below in the context of communication apparatus 310 as a UE. Process 400 may begin at block 410.

At block 410, process 400 may involve processor 312 of communication apparatus 310 transmitting, via transceiver 316, a request message to a network node (e.g., network apparatus 320). Process 400 may proceed from block 410 to block 420.

At block 420, process 400 may involve processor 312 receiving, via transceiver 316, an accept message responding to the request message from the network node, wherein the accept message comprises a cause value for releasing a session. Process 400 may proceed from block 420 to block 430.

At block 430, process 400 may involve processor 312 determining whether to re-establish the session according to the cause value.

In some implementations, process 400 may involve processor 312 performing, according to the cause value, at least one of the following actions: re-establishing the session, re-establishing the session in response to an expiration of a timer, and not re-establishing the session.

In some implementations, the accept message comprises a registration accept message or a service accept message

In some implementations, the session is a packet data unit (PDU) session.

In some implementations, the cause value comprises at least one of: 8 corresponding to “operator determined barring”, 26 corresponding to “insufficient resources”, 29 corresponding to “user authentication or authorization failed”, 36 corresponding to “regular deactivation”; 38 corresponding to “network failure”, 39 corresponding to “reactivation requested”, 46 corresponding to “out of LADN service area”, 67 corresponding to “insufficient resources for specific slice and data network name (DNN) and 69 corresponding to “insufficient resources for specific slice”.

In some implementations, process 400 may involve processor 312 performing, according to the cause value, at least one of the following actions: re-establishing the session in an event that the cause value is 36 or 39, re-establishing the session in response to an expiration of a timer in an event that the cause value is 26, 67, or 69, and not re-establishing the session in an event that the cause value is 8, 29, 38, or 46.

In some implementations, the network node is a core network node of a wireless communications network, and the wireless communications network is a fourth-generation (4G), fifth-generation (5G), or sixth-generation (6G) cellular network.

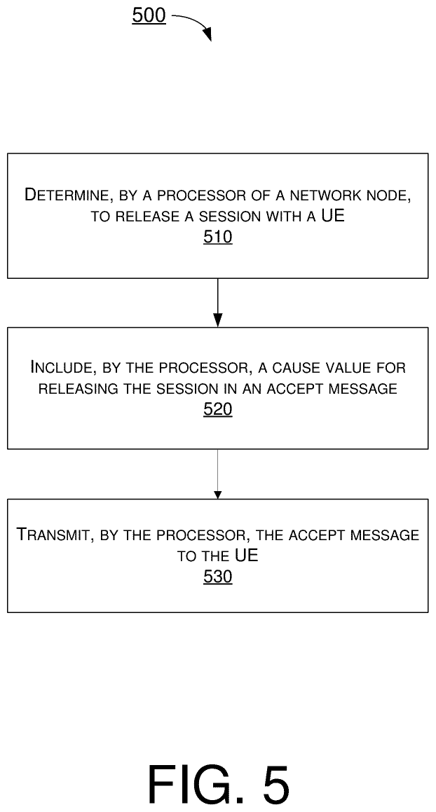

FIG. 5 illustrates an example process 500 in accordance with an implementation of the present disclosure. Process 500 may be an example implementation of the above scenarios/schemes, whether partially or completely, with respect to handling PDU session re-establishment procedures. Process 500 may represent an aspect of the implementation of features of network apparatus 320. Process 500 may include one or more operations, actions, or functions as illustrated by one or more of blocks 510, 520, and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any network entity in the 4G, 5G, or 6G network, including a base station, an AMF, or an SMF. Solely for illustrative purposes and without limitation, process 500 is described below in the context of network apparatus 320. Process 500 may begin at block 510.

At block 510, process 500 may involve processor 322 of network apparatus 320 determining to release a session with a UE (e.g., communication apparatus 310). Process 500 may proceed from block 510 to block 520.

At block 520, process 500 may involve processor 322 including a cause value for releasing the session in an accept message. Process 500 may proceed from block 520 to block 530.

At block 530, process 500 may involve processor 322 transmitting, via transceiver 326, the accept message to the UE.

In some implementations, the accept message comprises a registration accept message or a service accept message.

In some implementations, the session is a packet data unit (PDU) session.

In some implementations, the cause value comprises at least one of: 8 corresponding to “operator determined barring”, 26 corresponding to “insufficient resources”, 29 corresponding to “user authentication or authorization failed”, 36 corresponding to “regular deactivation”, 38 corresponding to “network failure”, 39 corresponding to “reactivation requested”, 46 corresponding to “out of LADN service area”, 67 corresponding to “insufficient resources for specific slice and data network name (DNN)” and 69 corresponding to “insufficient resources for specific slice”.

In some implementations, the cause value 36 or 39 indicates the UE to re-establish the session, the cause value 26, 67, or 69 indicates the UE to re-establish the session in response to an expiration of a timer, and the cause value 8, 29, 38, or 46 indicates the UE not to re-establish the session.

In some implementations, the network node is a core network node of a wireless communications network, and the wireless communications network is a fourth-generation (4G), fifth-generation (5G), or sixth-generation (6G) cellular network.

### Additional Notes

The herein-described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a request message to a network node;
receiving, by the processor, an accept message responding to the request message from the network node, wherein the accept message comprises a cause value for releasing a session; and
determining, by the processor, whether to re-establish the session according to the cause value.

2. The method of claim 1, wherein the determining of whether to re-establish the session according to the cause value further comprises:
performing, according to the cause value, at least one of:
re-establishing the session;
re-establishing the session in response to an expiration of a timer; and
not re-establishing the session.

3. The method of claim 1, wherein the accept message comprises a registration accept message or a service accept message.

4. The method of claim 1, wherein the session is a packet data unit (PDU) session.

5. The method of claim 1, wherein the cause value comprises at least one of:
8 corresponding to “operator determined barring”;
26 corresponding to “insufficient resources”;
29 corresponding to “user authentication or authorization failed”;
36 corresponding to “regular deactivation”;
38 corresponding to “network failure”;
39 corresponding to “reactivation requested”;
46 corresponding to “out of LADN service area”;
67 corresponding to “insufficient resources for specific slice and data network name (DNN)”; and
69 corresponding to “insufficient resources for specific slice”.

6. The method of claim 5, wherein the determining of whether to re-establish the session according to the cause value further comprises:
performing, according to the cause value, at least one of:
re-establishing the session in an event that the cause value is 36 or 39;
re-establishing the session in response to an expiration of a timer in an event that the cause value is 26, 67, or 69; and
not re-establishing the session in an event that the cause value is 8, 29, 38, or 46.

7. The method of claim 1, wherein the network node is a core network node of a wireless communications network, and the wireless communications network is a fourth generation (4G), fifth generation (5G), or sixth generation (6G) cellular network.

8. An apparatus, comprising:
a transceiver which, during operation, communicates wirelessly; and
a processor communicatively coupled to the transceiver such that, during operation, the processor performs operations comprising:
transmitting, via the transceiver, a request message to a network node;
receiving, via the transceiver, an accept message responding to the request message from the network node, wherein the accept message comprises a cause value for releasing a session; and
determining whether to re-establish the session according to the cause value.

9. The apparatus of claim 8, wherein, in determining whether to re-establish the session according to the cause value, the processor is further configured to perform operations comprising:
performing, according to the cause value, at least one of:
re-establishing the session;
re-establishing the session in response to an expiration of a timer; and
not re-establishing the session.

10. The apparatus of claim 8, wherein the accept message comprises a registration accept message or a service accept message.

11. The apparatus of claim 8, wherein the session is a packet data unit (PDU) session.

12. The apparatus of claim 8, wherein the cause value comprises at least one of:
8 corresponding to “operator determined barring”;
26 corresponding to “insufficient resources”;
29 corresponding to “user authentication or authorization failed”;
36 corresponding to “regular deactivation”;
38 corresponding to “network failure”;
39 corresponding to “reactivation requested”;
46 corresponding to “out of LADN service area”;
67 corresponding to “insufficient resources for specific slice and data network name (DNN)”; and
69 corresponding to “insufficient resources for specific slice”.

13. The apparatus of claim 12, wherein, in determining whether to re-establish the session according to the cause value, the processor is further configured to perform operations comprising:
performing, according to the cause value, at least one of:
re-establishing the session in an event that the cause value is 36 or 39;
re-establishing the session in response to an expiration of a timer in an event that the cause value is 26, 67, or 69; and
not re-establishing the session in an event that the cause value is 8, 29, 38, or 46.

14. The apparatus of claim 8, wherein the network node is a core network node of a wireless communications network, and the wireless communications network is a fourth-generation (4G), fifth-generation (5G), or sixth-generation (6G) cellular network.

15. A method, comprising:
determining, by a processor of a network node, to release a session with a user equipment (UE);
including, by the processor, a cause value for releasing the session in an accept message; and
transmitting, by the processor, the accept message to the UE.

16. The method of claim 15, wherein the accept message comprises a registration accept message or a service accept message.

17. The method of claim 15, wherein the session is a packet data unit (PDU) session.

18. The method of claim 15, wherein the cause value comprises at least one of:
8 corresponding to “operator determined barring”;
26 corresponding to “insufficient resources”;
29 corresponding to “user authentication or authorization failed”;
36 corresponding to “regular deactivation”;
38 corresponding to “network failure”;
39 corresponding to “reactivation requested”;
46 corresponding to “out of LADN service area”;
67 corresponding to “insufficient resources for specific slice and data network name (DNN)”; and
69 corresponding to “insufficient resources for specific slice”.

19. The method of claim 18, wherein the cause value 36 or 39 indicates the UE to re-establish the session, the cause value 26, 67, or 69 indicates the UE to re-establish the session in response to an expiration of a timer, and the cause value 8, 29, 38, or 46 indicates the UE not to re-establish the session.

20. The method of claim 15, wherein the network node is a core network node of a wireless communications network, and the wireless communications network is a fourth-generation (4G), fifth-generation (5G), or sixth-generation (6G) cellular network.
